(19) United States
(12) Patent Application Publication
(10) Pub. No.: US 2005/0044491 A1
(43) Pub. Date: Feb. 24, 2005

(54) Dynamic web serving system

(76) Inventor: Michael Peterson, El Dorado, KS (US)

Correspondence Address: LSI LOGIC CORPORATION, 1621 BARBER LANE, MS: D-106, MILPITAS, CA, 95035, US

(21) Appl. No.: 10/645,736

(22) Filed: Aug. 20, 2003

(51) Int. Cl. G06F 17/21

(52) U.S. Cl. 715/517

(57) ABSTRACT

A system and method for defining and creating web pages comprises a parser that reads a definition file, extracts data from one or more sources, and formats the data using a template file. The parser may create HTML pages that are immediately viewable. A single template file may be used for many different web pages, allowing a web site to have a consistent look and feel while keeping the administration costs to a minimum. The content for each web page may be modified by changing the definition file.

### BACKGROUND OF THE INVENTION

a. Field of the Invention

The present invention pertains to web servers and specifically to web servers that dynamically create viewable web pages.

b. Description of the Background

Web interfaces to various computer systems are becoming more and more ubiquitous. As the amount of information available through the web increases, the number of web pages that must be maintained likewise increases. With an increase in the volume of web pages, the administration of the web pages becomes more difficult.

Web designers may develop a specific ‘look and feel’ for their web sites that have a specific set of colors, text, graphics, or other visual elements that give a web site a cohesiveness and continuity. By maintaining a consistent look and feel, the web designer may create a desired experience for the web visitor.

Various tools are commercially available to aid the web designer in creating a consistent and cohesive experience throughout a web site. Such technologies include the use of style sheets or by creating web pages using various editing tools that enable the designer to quickly create several similar web pages.

Dynamic web pages are those that are created on demand when a browser requests a page. In a standard dynamic web page, portions of the page may be pulled from disparate sources to create the desired page. For example, a page for a newspaper may have a section of a page that is pulled from a real time weather server and inserted in a predetermined area of the displayed page.

When a web site has many dynamic web pages, the complexity of maintaining the web pages grows. If a web designer changes the look and feel of the web site, the designer may be required to edit all of the dynamic web pages individually. Because of the enormity of the task, such changes are generally done infrequently.

It would therefore be advantageous to provide a system and method for dynamically creating web pages having a consistent look and feel while having to maintain as few files as possible. It would be further advantageous to provide a system and method where new web content may be added to a web site with a minimum of complexity.

### SUMMARY OF THE INVENTION

The present invention overcomes the disadvantages and limitations of previous solutions by providing a system and method for creating a web page by defining a definition file that is passed to a parser. The definition file defines a template file and one or more content locations. The parser retrieves the content from the content locations, formats the content using the template file, and creates an HTML file.

An embodiment of the present invention may therefore comprise a method for serving a web page comprising: receiving a request for a web page from a client; parsing a predefined definition file with a parser, said predefined definition file comprising at least one reference to a first predefined template file and at least one content file, said first predefined template file comprising formatting information for said web page; creating said web page by combining said first predefined template file with said at least one content file; and transmitting said web page to said client.

Another embodiment of the present invention may comprise a method for serving a web page comprising: receiving a request for a web page from a client; parsing a predefined definition file with a parser, said predefined definition file comprising at least one reference to a plurality of predefined template files and at least one content file, said plurality of predefined template files comprising formatting information for said web page; selecting one of said plurality of predefined template files with said parser; creating said web page by combining said one of said plurality of predefined template files with said at least one content file; and transmitting said web page to said client.

Yet another embodiment of the present invention may comprise a server system for serving web pages comprising: a predefined template file that comprises formatting information; a predefined definition file that comprises at least one reference to said predefined template file and at least one content file; and a server program operable to receive a request from a client program, said request including a pointer to said definition file, parse said predefined definition file, create said web page by combining said first predefined template file with said at least one content file, and transmit said web page to said client.

Still another embodiment of the present invention may comprise a server system for serving web pages comprising: a plurality of predefined template files that contain formatting information; a predefined definition file that contains at least one reference to said plurality of predefined template files and at least one content file; and a server program operable to receive a request for a web page from a client, said request being a pointer with a reference to said predefined definition file, said server program further operable to parse said predefined definition file and select one of said plurality of predefined template files, create said web page by combining said one of said plurality of predefined template files with said at least one content file, and transmit said web page to said client.

The advantages of the present invention are that a variety of web pages may be defined and created requiring a minimum of code writing. Further, system and method may be used to give a multi-page website a unified look and feel while keeping the administration and update costs to a minimum.

### BRIEF DESCRIPTION OF THE DRAWINGS

In the drawings,

FIG. 1 is an illustration of an embodiment of the present invention showing a web page server system.

FIG. 2 is an illustration of an embodiment of the present invention showing a file structure for an unconstructed web page.

FIG. 3 is an illustration of an embodiment of the present invention showing a method of creating a web page using the parser described in FIG. 1.

### DETAILED DESCRIPTION OF THE INVENTION

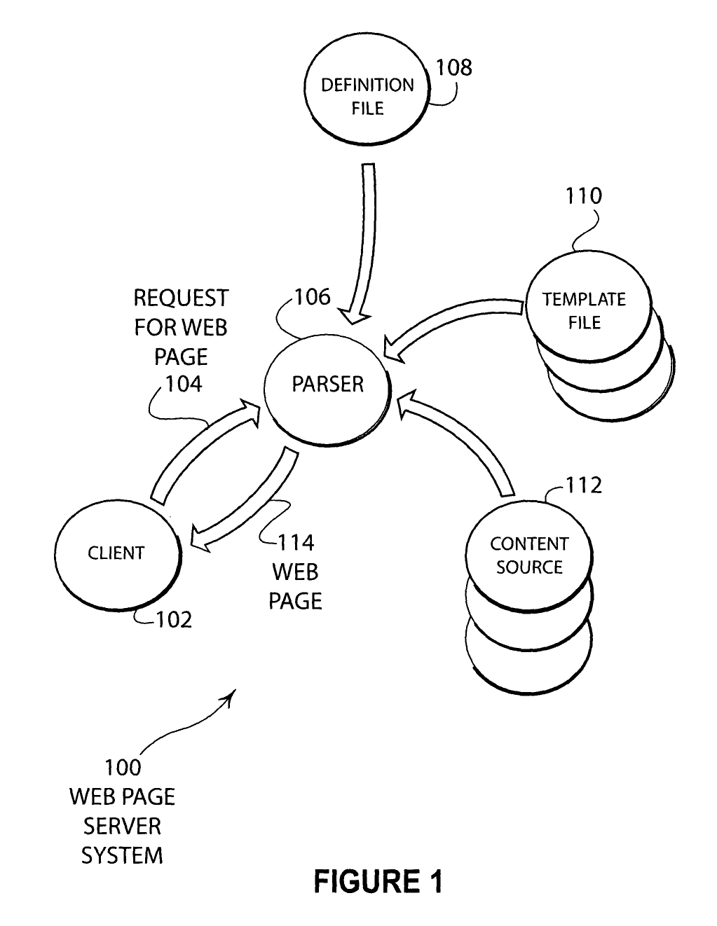

FIG. 1 illustrates an embodiment 100 of the present invention showing a web page server system. A web client 102 sends a request for a web page 104 to a parser 106. The parser 106 reads a definition file 108, one or more template files 110, and one or more content files 112. The parser 106 combines the template files 110 and content source 112 to produce a web page 114 that is sent to the client 102.

The request for a web page 104 may be a request for the parser 106 with the definition file 108 as a variable. In such an embodiment, the request may trigger the parser to operate and thereby call the definition file 108. The definition file 108 may include links to the template files 110 and content source 112, which are used together to produce the web page 114.

The embodiment 100 allows a standard set of template files 110 to be applied to various content sources 112 to give a unified ‘look and feel’ to a set of web pages. For example, a single set of template files 110 may be defined for a large website that may contain hundreds or thousands of content sources 112. The formatting requirements that make up a website's ‘look and feel’ may be completely defined in a handful of template files 110. The template files 110 may be maintained, updated, and changed without having to change any of the content sources 112. Likewise, the content sources 112 may be created without regard to the ‘look and feel’ of the website. In fact, the content sources 112 may contain raw, unformatted text, graphics, or data that is later formatted and configured according to the template files 110. The definition file 108 may provide a link between the template files 110 and content sources 112 for the parser 106.

The request for a web page 104 may take various forms. As described above, the request may be of the form of a call to the parser with the definition file 108 as a variable. Such a call may look like:
http://www.server.com/parser.php?file=definition.php

The parser is initiated by calling ‘parser.php’, and the definition file is called by sending the variable ‘file=definition.php’.

In another embodiment, the call may be made to the definition file 108 that in turns causes the parser to execute. Those skilled in the arts may configure the request for a web page 104 in various forms while still maintaining within the spirit and intent of the present invention.

The definition file 108 may define the various components that are used by the parser 106 to create the web page 114. In some embodiments, the definition file 108 may contain filenames or locations for the specific template files 110 and content sources 112 that make up a web page. Additionally, the definition file 108 may contain variables or other data that may be used by the parser 106 or passed to the template files 110 or content sources 112.

The template files 110 may contain the formatting, page layout, scripts, content, or other items that may be used across many different web pages to give a consistent ‘look and feel’ to a website. The template files 110 may include actual HTML code or may be written in a format or language that is readable by the parser 106. In some embodiments, the template files 110 may be written in PHP, Perl, or other language that is amenable to web page creation. The language or format of the template files 110 are interpreted by the parser 106.

The content sources 112 may be a raw, unformatted text, graphics, or data file. In some cases, the content sources 112 may be calls to functions, subroutines, programs, or other executable instructions wherein the executable instructions return a response that is then formatted according to the template files 110. For example, one of the content sources 112 may be a call to a routine that performs a query against a database to return a value. The value is then formatted and presented as part of the web page 114. A variable may be stored in the definition file 108, received as part of the request 104, generated by the parser 106, or created and maintained in any useful manner. The variable may be passed to the content source 112 that may perform analysis, computation, query, or other type of manipulation of the variable to return some form of data. The subsequent data may then be incorporated into the web page 114 using the template file 110.

In some embodiments, the content sources 112 may contain formatted text or graphics. The formatted text or graphics may be partially formatted, such as having highlighting or bold face tags, or may be fully formatted with colors or other attributes that are intended to override similar attributes that may be contained in the template files 110.

In other embodiments, any formatting within the content sources 112 may be overridden by the formatting provided in the template files 110. In such an embodiment, a new ‘look and feel’ may be provided by applying the formatting of the template files 110 to an existing web page contained in a content sources 112.

The parser 106 may provide several analysis functions for the request 104. For example, the request 104 may include several variables that are hidden from the user such as the language or address of the requestor. Such variables may be analyzed by the parser to select a template file 110 or content source 112 that is tailored to the language of the requesting client 102. Additionally, the parser 106 may ensure that the client 102 is authorized to view the requested web page. Such an embodiment may include reading cookies or other data that is located on the client 102.

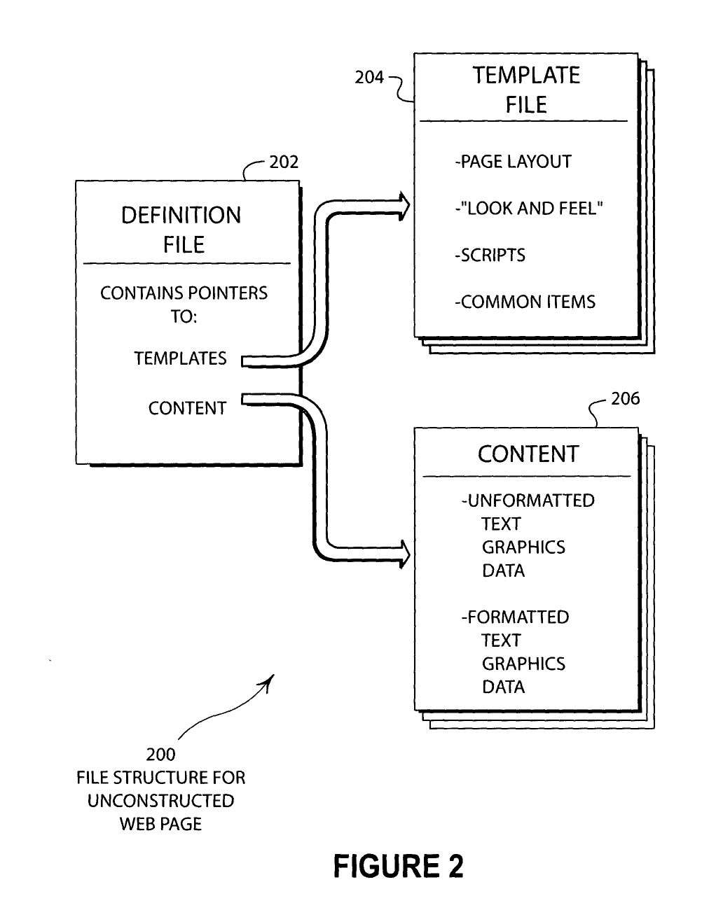

FIG. 2 illustrates an embodiment 200 of the present invention showing a file structure for an unconstructed web page. The definition file 202 contains pointers to template files 204 and contents 206. The template files 204 may include information relating to the page layout, “look and feel” of the final web page, scripts, and items that are common to multiple pages. The content 206 may include unformatted text, graphics, and data. Additionally, the content 206 may include formatted text, graphics, and data.

The definition file 202 may be the place where the overall web page is defined. The definition file 202 links the template file 204 that defines the “look and feel” amongst other aspects of the web page, with the content 206 that the web page displays. In an example of a website for a newspaper, several stories may be created as content 206. Rather than creating individual web pages for each of the several stories, wherein all of the web pages would have the same formatting and “look and feel” attributes, a website administrator, using the present invention, creates individual definition files 202 for each of the individual stories. In such an embodiment, the web page creation only requires a short definition file 202. All of the formatting, including the “look and feel” would be added to the web page when the page is requested.

The definition file 202 may include references to several template files 204 as well as variables used by the parser or content. One of the template files 204 may be selected when the page is requested. For example, the request for the web page may include certain parameters, such as the domain name of the requesting client, the language of the client, and other such information. One or more of such parameters, such as the language parameter, for example, may be used by the parser to select a template file 204 that is specifically designed for that particular language. In another example, one or more of the parameters may be passed to one of the content sources 206 for evaluation and return of data that is formatted and incorporated in the resultant web page.

In an example of a newspaper website, current stories less than 24 hours old may be displayed in a particular format while older stories may be displayed with a different format. In such an example, there may be a separate template for current stories and older stories. A definition file for the web page for each story may include references to both template files as well as a variable or other statement that defines when to use each of the template files. When a page is requested, the parser may run and evaluate the variable contained within the definition file 202, and thereby decide which template file to apply to the content of the story. In the example, if a web page was requested for a story that was older than 24 hours, the content would be displayed with the template file corresponding to the older stories.

The template file 204 may contain some or all of the formatting information that is common among similar web pages. For example, the template file may include page layout information such as headers, footers, navigation bars, location and position of various graphics, text, and other elements. In some cases, the template file 204 may contain graphical and text elements that are common to the similar web pages. Such information may include common navigation elements, common banner titles and graphics, and the like.

In some embodiments, the template file 204 may contain the overall layout of the final web page. For example, a portion at the top of the page may be reserved for a banner, a portion on the left may be reserved for navigation buttons, and the remaining portion may be reserved for the generic body of the web page. When the definition file is created, the definition file may include a link to the template file and various content locations. One content location may include the banner portion of the web page while another content location may include the navigation buttons. A third content location may include the content for the body of the web page.

By placing the overall formatting of the web page in the template file 204, the look and feel of many web pages may be closely controlled and similar, without having to maintain many different web pages. Further, the formatting of the web site may be updated, changed, and improved by only changing the template files.

In other embodiments, the template file 204 may contain common graphics, text, and other data that are used across many web pages. Those skilled in the art may place differing amounts of formatting, text, graphics, and other types of information in the template files based on the specific application while keeping within the spirit and intent of the present invention.

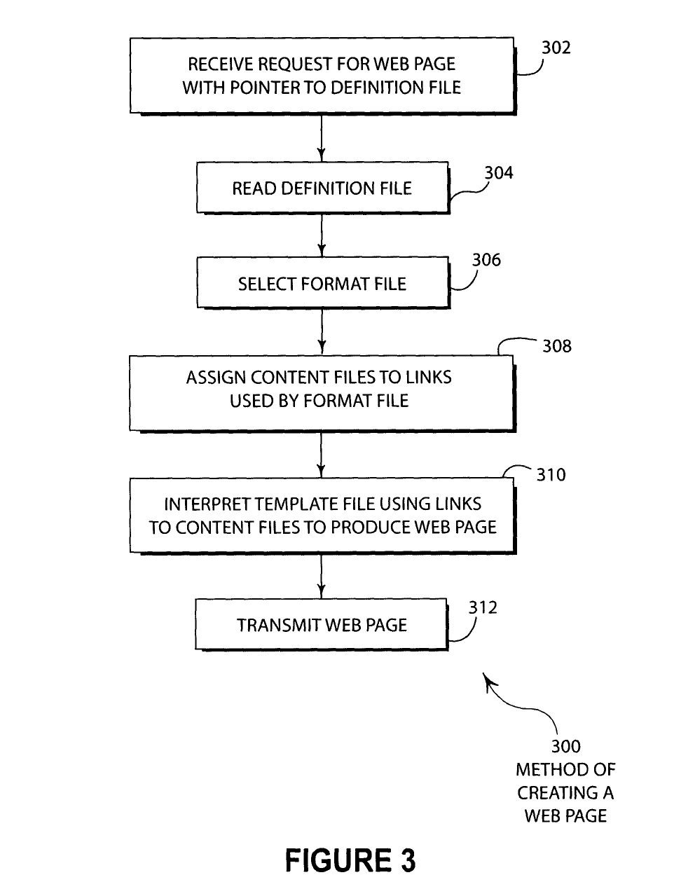

FIG. 3 illustrates an embodiment 300 of the present invention showing a method of creating a web page using the parser described in FIG. 1. A request for a web page is received in block 302 with a pointer to a definition file. The definition file is read in block 304 and a format file is selected in block 306. The content files defined in the definition file are assigned to links in block 308. The template file is interpreted using the links defined in block 308 to produce a web page in block 310. The web page is transmitted to the requester in block 312.

The embodiment 300 illustrates a method whereby a definition file, a template file, and one or more content files may be used to collectively generate a web page. The definition file indicates the template file and the content files to be used to generate the web page. Each of the content files are assigned a link, such as having the content file name being assigned to a variable name. The link or variable name may be referred to in the template file. By defining the content files to the links, the template file may be interpreted and the resulting web page may be created.

For example, the template file may have variable names banner_file, navigation_file, and content_file. The parser assigns actual file names to the variable names listed above. As the parser interprets the template file that uses the variable names listed above, the parser may substitute the contents of the file names into the template file at the location where the variable is used. By substituting the contents of the contents file into the template file, a web page may thereby be constructed.

One of several format files may be selected in block 306. Various criteria and methods may be used to select the appropriate template file for the particular request. For example, the request received in block 302 may contain certain parameters that may be evaluated. Such parameters include information relating to the client and user of the client, such as language, location, domain name, email address, browser type, computer type, and other information. Additionally, a cookie or other data storage system may be queried to determine authenticity, permissions, preferences, or other information that may be used to select an appropriate template file. Such data may also be passed to a content source for the generation of the content for the requested web page.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. A method for serving a web page comprising:
receiving a request for a web page from a client;
parsing a predefined definition file with a parser, said predefined definition file comprising at least one reference to a first predefined template file and at least one content file, said first predefined template file comprising formatting information for said web page;
creating said web page by combining said first predefined template file with said at least one content file; and
transmitting said web page to said client.

2. The method of claim 1 wherein said predefined definition file comprises at least one reference to a second predefined template file, the method further comprising:
selecting said first predefined template file.

3. The method of claim 1 wherein said first predefined template file comprises page layout information.

4. The method of claim 1 wherein said parser is operable to determine if said client is authorized to view said at least one content file.

5. The method of claim 1 wherein said request comprises at least one variable and said parser is operable to pass said at least one variable to said at least one content file.

6. The method of claim 1 wherein said request is a pointer to said parser with a reference to said predefined definition file.

7. A method for serving a web page comprising:
receiving a request for a web page from a client;
parsing a predefined definition file with a parser, said predefined definition file comprising at least one reference to a plurality of predefined template files and at least one content file, said plurality of predefined template files comprising formatting information for said web page;
selecting one of said plurality of predefined template files with said parser;
creating said web page by combining said one of said plurality of predefined template files with said at least one content file; and
transmitting said web page to said client.

8. The method of claim 7 wherein said request comprises a variable used by said parser in said step of selecting.

9. The method of claim 8 wherein said variable is passed from said client to said parser.

10. The method of claim 9 wherein said variable denotes a language preference.

11. The method of claim 9 wherein said variable denotes a descriptor of a computer system on which said client is operating.

12. The method of claim 7 wherein said request is a pointer to said parser with a reference to said predefined definition file

13. A server system for serving web pages comprising:
a predefined template file that comprises formatting information;
a predefined definition file that comprises at least one reference to said predefined template file and at least one content file; and
a server program operable to receive a request from a client program, said request including a pointer to said definition file, parse said predefined definition file, create said web page by combining said first predefined template file with said at least one content file, and transmit said web page to said client.

14. The server system of claim 13 wherein said template file comprises page layout information.

15. The server system of claim 13 wherein said server is further operable to determine if said client is authorized to view said at least one content file.

16. The server system of claim 13 wherein said request comprises at least one variable and said server is operable to pass said at least one variable to said at least one content file.

17. A server system for serving web pages comprising:
a plurality of predefined template files that contain formatting information;
a predefined definition file that contains at least one reference to said plurality of predefined template files and at least one content file; and
a server program operable to receive a request for a web page from a client, said request being a pointer with a reference to said predefined definition file, said server program further operable to parse said predefined definition file and select one of said plurality of predefined template files, create said web page by combining said one of said plurality of predefined template files with said at least one content file, and transmit said web page to said client.

18. The server system of claim 17 wherein said request comprises a variable used by said parser in said step of selecting.

19. The server system of claim 18 wherein said variable is passed from said client to said parser.

20. The server system of claim 19 wherein said variable denotes a language preference.

21. The server system of claim 19 wherein said variable denotes a descriptor of a computer system on which said client is operating.
